(19) United States
(12) Patent Application Publication
(10) Pub. No.: US 2007/0279915 A1
(43) Pub. Date: Dec. 6, 2007

(54) Fluorescent Volume Light Source With Air Gap Cooling

(75) Inventors: Todd S. Rutherford, Cincinnati, OH (US); Michael Dolgin, Cincinnati, OH (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/748,666

(22) Filed: May 15, 2007

Related U.S. Application Data
(60) Provisional application No. 60/803,821, filed on Jun. 2, 2006.

(51) Int. Cl. F21V 7/00

(52) U.S. Cl. 362/341

(57) ABSTRACT

An embodiment of the invention is an illumination system including a source of incoherent light capable of generating light in a first wavelength range and an elongate body that emits light in a second wavelength range when illuminated by light in the first wavelength range. The body further includes an extraction surface. A first non-extraction surface extends along at least a portion of the length of the body and is disposed so as to share a common edge with the extraction surface. At least some of the light at the second wavelength is totally internally reflected at the non-extraction surface. At least one external reflector is disposed proximate to the non-extraction surface so as to create a gap of less than 100 microns between the external reflector and the non-extraction surface.

### CROSS REFERENCE TO RELATED APPLICATION

This application claims the benefit of U.S. Provisional Patent Application No. 60/803,821, filed Jun. 2, 2006, the disclosure of which is incorporated by reference herein in its entirety.

### FIELD OF THE INVENTION

The invention relates to light sources, and particularly to light sources that might be used in illumination systems, for example projection systems.

### BACKGROUND

The brightness of illumination sources based on a type of light source is typically limited by the brightness of the light source itself. For example, an illumination source that uses light emitting diodes (LEDs) typically has a brightness, measured in power per unit area per unit solid angle), the same as or less than that of the LEDs because the optics that collect the light from the LEDs will, at best, conserve the étendue of the LED source. Accordingly, the brightness of the illumination source is limited.

In some applications of illumination sources, such as projector illumination, illumination by LEDs is not a competitive option because the brightness of the LEDs that are currently available is too low. This is particularly a problem for the generation of green illumination light, a region of the visible spectrum where the semiconductor materials used in LEDs are less efficient at generating light.

Other types of light sources may be able to produce a sufficiently bright beam of light but they also suffer from other drawbacks. For example, a high-pressure mercury lamp is typically able to provide sufficient light for a projection system, but this type of lamp is relatively inefficient, requires a high voltage supply, contains toxic mercury, and has limited lifetime. Solid-state sources, such as LEDs are more efficient, operate at lower voltages, contain no mercury, and are therefore safer, and have longer lifetimes than lamps, often extending to several tens of thousands of hours.

Therefore, there exists a need for a solid-state light source that can be used in illumination systems that is brighter than current light sources.

### SUMMARY OF THE INVENTION

An embodiment of the invention is an illumination system including a source of incoherent light capable of generating light in a first wavelength range and an elongate body that emits light in a second wavelength range when illuminated by light in the first wavelength range. The body further includes an extraction surface. A first non-extraction surface extends along at least a portion of the length of the body and is disposed so as to share a common edge with the extraction surface. At least some of the light at the second wavelength is totally internally reflected at the non-extraction surface. At least one external reflector is disposed proximate to the non-extraction surface so as to create a gap of less than 100 microns between the external reflector and the non-extraction surface.

### BRIEF DESCRIPTION OF THE DRAWINGS

The invention may be more completely understood in consideration of the following detailed description of various embodiments of the invention in connection with the accompanying drawings, in which:

FIGS. 1A, 1B, 1C, 1D, 1E and 1F schematically illustrate an embodiment of a volume fluorescent light unit according to principles of the present invention;

FIG. 2 schematically illustrates another embodiment of a volume fluorescent light unit, with a partially tapered body and tiled reflectors, according to principles of the present invention;

FIG. 3 schematically illustrates another embodiment of a fluorescent body with a partially tapered body and non-tiled reflectors, according to principles of the present invention;

FIG. 4A schematically illustrates embodiments of a volume fluorescent light unit with reflectors and heat sinks, according to principles of the present invention;

FIG. 4B schematically illustrates embodiments of a volume fluorescent light unit with a curved reflector and a heat sink, according to principles of the present invention;

FIG. 5 schematically illustrates an embodiment of a projection system that uses a volume fluorescent light unit according to principles of the present invention;

FIG. 6 shows a graph of the extraction efficiency at various distances from the small end of the body of an experimental volume fluorescent light unit;

FIG. 7 shows a graph of the extraction efficiency at various distances from the small end of the body of an experimental volume fluorescent light unit;

FIG. 8 shows a graph of the extraction efficiency versus external mirror reflectivity; and

FIG. 9 shows a graph of the thermal resistance of various air gap distances.

Like numerals in different figures refer to similar elements. While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to light sources and is more particularly applicable to light sources that are used in illumination systems where a high level of brightness is required.

The brightness of a light source is measured in optical power (Watts) divided by the étendue. The étendue is the product of the area of the light beam at the light source times the square of the refractive index times the solid angle of the light beam. The étendue of the light is invariant, i.e. if the solid angle of the light beam is reduced without loss of the light, then the area of the beam is increased, e.g. by increasing the emitting area of the light source. Since the étendue is invariant, the brightness of the light generated by the light source can only be increased by increasing the amount of light extracted from the light source. If the light source is operating at maximum output, then the brightness of that light source can no longer be increased.

The optical power of the light beam may be increased through the use of additional light sources. There are limits, however, as to how much the optical power and brightness of the light beam can be increased by simply adding more light sources. The optical system that directs the light beam to the target accepts light that is within certain aperture and cone angle limits only. These limits depend on various factors, such as the size of the lenses and the f-number of the optical system. The addition of more light sources does not provide an unlimited increase in the optical power or brightness of the light beam because, at higher numbers of light sources, an increasingly smaller fraction of the light from an added light source lies within the aperture and cone angle limits of the optical system.

The invention is believed to be useful for producing a concentrated light source, having a relatively high brightness, using a number of light sources that have a relatively lower brightness, such as light emitting diodes. The light from the lower brightness light sources is used to optically pump a volume of fluorescent material. The fluorescent material absorbs the light emitted by the low brightness light source and fluorescently emits light at a different wavelength. The fluorescent light is typically emitted isotropically by the fluorescent material. At least some of the fluorescent light can be directed within the volume to a light extraction area. The pump surface area is the area of the fluorescent volume that is used for coupling the relatively low brightness, short wavelength pump light into the volume, and the extraction area is that area of the fluorescent volume from which fluorescent light is extracted. A net increase in brightness can be achieved when the pump surface area is sufficiently large compared to the extraction area.

In the following description, the term fluorescence covers phenomena where a material absorbs light at a first wavelength and subsequently emits light at a second wavelength that is different from the first wavelength. The emitted light may be associated with a quantum mechanically allowed transition, or a quantum mechanically disallowed transition, the latter commonly being referred to as phosphorescence. If the fluorescent material absorbs only a single pump photon before emitting the fluorescent light, the fluorescent light typically has a longer wavelength than the pump light. In some fluorescent systems, however, more than one pump photon may be absorbed before the fluorescent light is emitted, in which case the emitted light may have a wavelength shorter than the pump light. Such a phenomenon is commonly referred to as upconversion fluorescence. In some other fluorescent systems, light is absorbed by an absorbing species in the fluorescent material and the resulting energy transferred to a second species in the material nonradiatively, and the second species emits light. As used herein, the terms fluorescence and fluorescent light are intended to cover systems where the pump light energy is absorbed by one species and the energy is re-radiated by the same or by another species. This type of device is illustrated and described in U.S. patent application Ser. No. 11/092,284, the contents of which are incorporated by reference in their entirety herein.

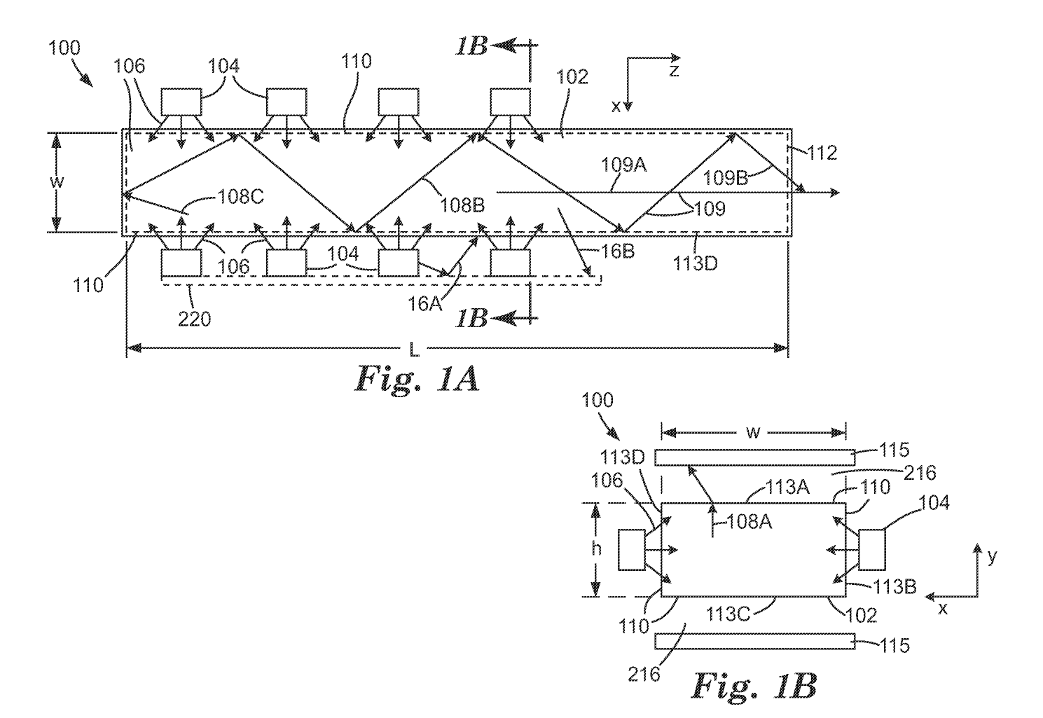

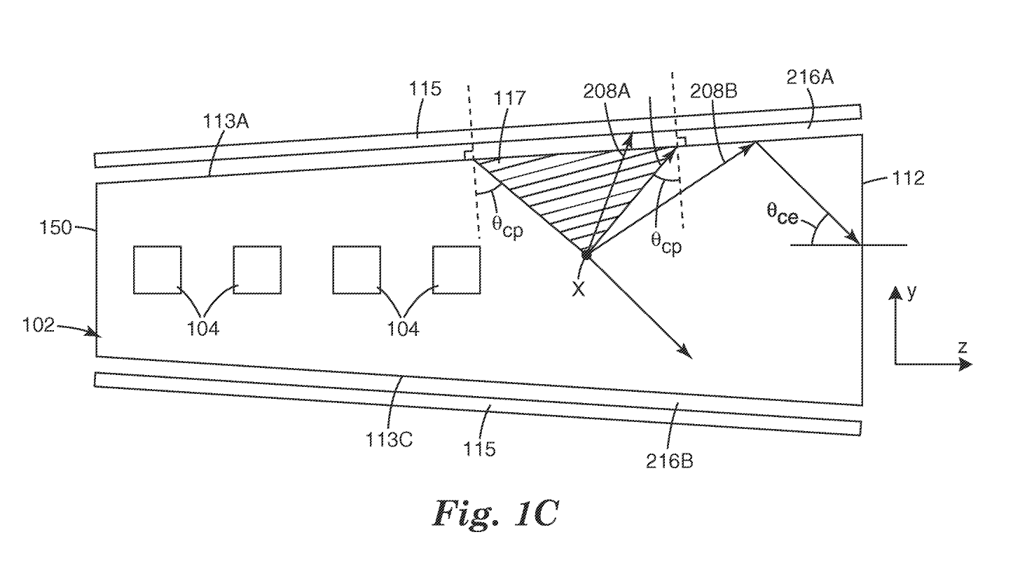

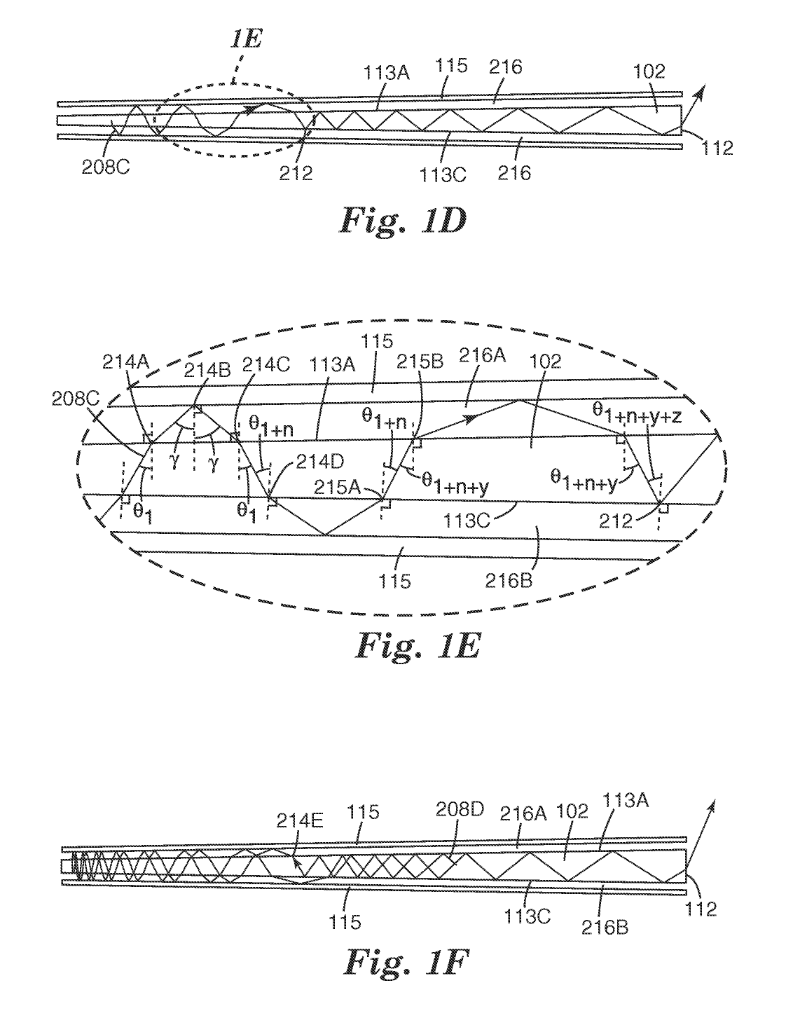

One particular embodiment of the invention is schematically illustrated in FIGS. 1A, 1B and 1C which show top, cross-sectional, and side views, respectively, of a volume fluorescent light unit (or illumination system) 100 that has a body 102 containing fluorescent material, a number of light emitters 104 that emit light 106 into the body 102, and external reflectors 115 which reflects light emitted from the body 102 back into the body 102. The external reflectors are spaced from body 102 a certain distance forming gaps 216A and 216B.

A Cartesian coordinate system is provided in FIGS. 1A, 1B and 1C to aid in the description of the volume fluorescent light unit 100. The directions of the coordinate system have been arbitrarily assigned so that the output fluorescent light propagates generally along the z-direction, which is parallel to the longitudinal dimension of the body, having a length, L. The width of the body 102, w, is measured in the x-direction and the height of the body 102, h, is measured in the y-direction. It should be noted that the body 102 is tapered along its length. In the current embodiment, best illustrated in FIG. 1C, the height of the body 102, h, along the y-direction increases in size along the length of the body 102, L, i.e., along the z-direction.

In this particular embodiment, the pump light enters the body 102 through pump surfaces 110 and fluorescent output light 109 passes out the body 102 through an extraction face 112. External reflectors 115A and 115B (referred to generally as “external reflectors 115”) are positioned immediately adjacent non-extraction surfaces 113A-113D (referred to generally as “non-extraction surfaces 113”). The pump surfaces 110 are also non-extraction surfaces 113. While four non-extraction surfaces 113 are illustrated in the current embodiment it should be understood that any number of non-extraction surfaces 113 as well as any number of pump surfaces 110 may be included in the current invention. Additionally, while it is illustrated that external reflectors 115A and 115B are disposed next to non-extraction surfaces 113A an 113C it is contemplated that all non-extraction surfaces 113 may be utilized with external reflectors 115. In the current embodiment, non-extraction surfaces 113 extend along length L of body 102. In the illustrated embodiment, the body 102 is tapered so that the largest cross sectional area of the body occurs at the extraction face 112. A rear surface 150 is also illustrated and may or may not be orthogonal to one or more of the non-extraction surfaces 113 and may or may not be substantially parallel to the extraction surface.

Some of the fluorescent light that passes out of the body 102 through the extraction face 112, exemplified by light ray 109A, may pass directly out of the body 102 without reflection at any surface of the body 102. Other portions of the output fluorescent light 109, exemplified by light ray 109B, may have been reflected within the body 102 through the process of total internal reflection (TIR).

Further, some portions of the fluorescent light, exemplified by ray 108A, may be transmitted through non-extraction surface 113A of the body 102. Other portions of the fluorescent light, exemplified by ray 108B, are reflected within the body 102.

There are several practical reasons for leaving gaps 216A and 216B referred to generally as “gaps 216”) between the external reflectors 115 and the body 102, instead of placing reflectors 115 directly against body 102. One main reason is that gaps 216 allow for efficient TIR conditions. The residual loss of a TIR reflection can be very low (less than 0.1% per bounce). As discussed further, below, this TIR effect is caused by the movement from the high index material of the body 102 into low index material (e.g., air, having refractive index approximately 1.0). By creating gap 216, a low index material such as air (or other material) can fill the gap 216. Utilizing the TIR effect is better than placing the reflectors 115 directly against the body 102 because unless the reflectivity of the reflector is very high over a wide range of angles, it will increase the overall loss after the many reflections needed to reach the end of the body 102. Additionally, coating the sides of the body with a reflective surface would be expensive since the coating would need to come very close to the body edges and have >99.5% reflectivity (requiring many layers for a dielectric stack reflector, and multiple coating cycles would be needed to coat all of the non-extractions faces).

It is useful to consider the ranges of angles for which light generated within the fluorescent body 102 is either reflected (through TIR) within the body 102 or escapes from the body 102. Referring now to FIG. 1C, we consider light that is fluorescently generated at point X. A particular angle at the non-extraction surface 113A, θ_{cp}, can be calculated from the expression:

θ_{cp}=sin⁻¹ (nₚ/n), (5)

where nₚ is the refractive index on the outside of the non-extraction surface 113A (in this case within gap 216A) and n is the refractive index of the body 102. This angle θ_{cp} is known as the “critical angle”. Hatched region 117 shows the range of angles that are less than θ_{cp}. If the non-extraction surface 113A is in air (i.e., if the substance filling gap 216A is air), the value of nₚ is approximately equal to 1.

If light propagating from point X, for example, light ray 208B, lies outside the cone indicated by the hatched region 117, then the light ray 208B is totally internally reflected by the non-extraction surface 113A. Thus, in order to reduce the amount of light lost through the non-extraction surface 113A, i.e. reduce θ_{cp}, it is generally preferred that the value of n is larger. If light, for example ray 208A, is incident at the non-extraction surface 113A so as to form an angle with a line normal to non-extraction surface (its Angle of Incidence, or AOI) and this angle is less than the critical angle, θ_{cp}, then the light 208A is transmitted through the non-extraction surface 113A.

With the addition of external reflectors 115, this light (exemplified by ray 208A) can be recaptured. FIG. 1D is a schematic of light unit 100 (illustrated without light emitters for clarity) showing an example of how this works. Light ray 208C which initially does not meet the TIR condition is reflected from the external reflector 115. After reflection and re-entry through non-extraction surface 113A, it has a larger AOI at the body/air interface at non-extraction surface 113C than it did at the previous interaction with the body/air interface at non-extraction surface 113A, and is closer to TIR. For the ray 208C shown, it takes several bounces off the external reflectors 115, with transmission through the body 102 in between, before the AOI has been changed enough to meet the TIR condition in the body 102. Once TIR is achieved (shown at point 212), the ray 208C is confined within the body 102 until it reaches extraction face 112.

To more clearly illustrate this process, a portion of FIG. 1D defined by a circle labeled “1E” has been enlarged into FIG. 1E. Again, light ray 208C encounters non-extraction surface 113A at point 214A. An AOI of θ is defined between the path of the light ray 208C and a normal line 215 to non-extraction surface 113A which passes through point 214A. Light ray 208C is refracted away from normal as it passes into gap 216A. Gap 216A is the space between external reflector 115 and non-extraction surface 113A. Light ray 208C reflects off of external reflector 115 at point 214B. The light ray 208C re-enters body 102 at point 214C creating an angle of refraction θ₁. The angle of incidence at point 214A and the angle of refraction at point 214C of light ray 208C are substantially equal. Light ray 208C travels through body 102 until it encounters non-extraction surface 113C at point 214D. Light ray 208C defines an AOI of θ₁+n, which is larger than that of the AOI at points 214A and 214C. This is due to the non-parallel relationship between the normal line 215A at non-extraction surface 113A and a normal line 215B at non-extraction surface 113C. The skewed relationship between the normals (215A and 215B) is due to the non-parallel relationship of the sides of tapered body 102. The AOI increases with each successive encounter by light ray 208C as it exits either non-extraction surface 113A or non-extraction surface 113C, and passes into gap 216A or 216B. Eventually the AOI is large enough that it is greater than the Critical Angle, and light ray 208C begins to TIR within the body 102, such as is shown at point 212.

As illustrated in FIG. 1F, some backward propagating rays (i.e. rays that propagate towards narrowing portion of body 102 as illustrated by ray 208D) that initially meet the TIR condition are eventually coupled out of the slab sides (since the AOI of the light ray falls below the Critical Angle). In the illustrated embodiment, light ray 208D initially has an AOI greater than the Critical Angle as it encounters non-extraction surfaces 113A or 113C, but after each reflection from the non-extraction surfaces 113A or 113C, the angle of incidence decreases. This occurs since light ray 208D is traveling opposite that of light ray 208C (discussed previously with respect to FIG. 1E). Since light ray 208D does not reach the end of body 102 before its AOI is reduced below the TIR angle, it passes out of the body 102 (as illustrated at point 214E). The addition of the external reflectors 115 prevents the loss of light ray 208D. After losing TIR, ray 208D is reflected from the external reflectors 115, and after each bounce it has a progressively smaller AOI as it exits body 102 at either of non-extraction surfaces 113A or 113C, until the AOI passes zero degrees (is turned around) and starts propagating in the forward direction (i.e., towards the extraction face 112 and towards the widening portion of body 102). Then the ray 208D proceeds as in the forward case in FIG. 1D, eventually returns to TIR within the body 102, and is extracted from the extraction face 112.

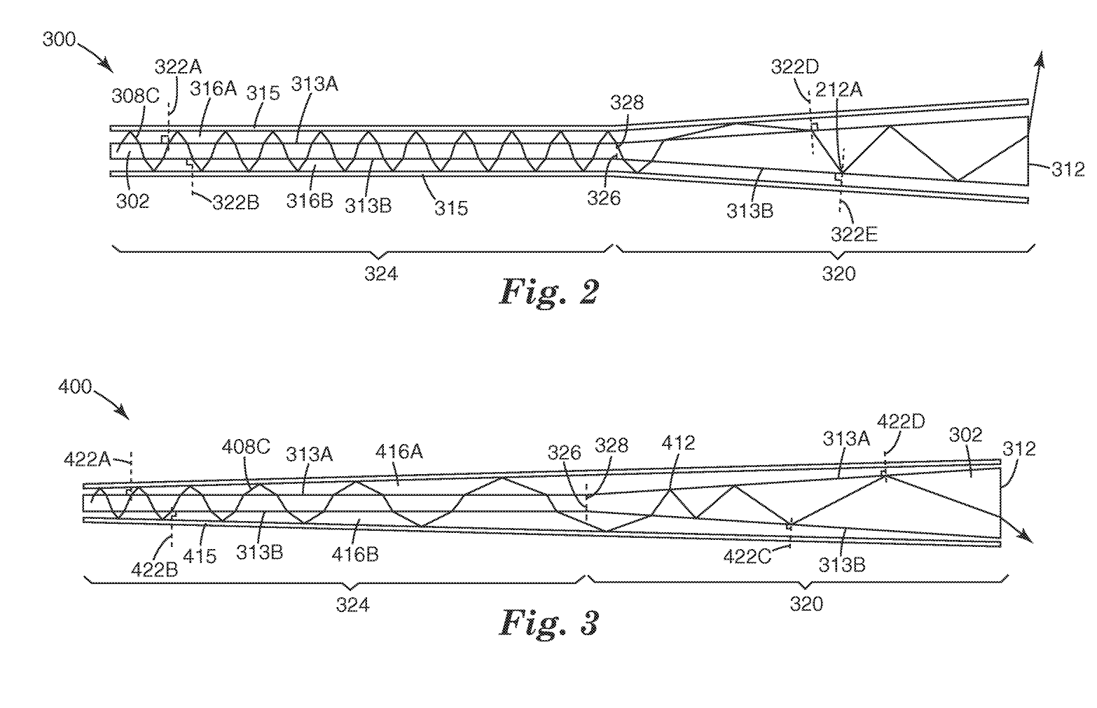

As illustrated in FIG. 2, light unit (or illumination system) 300 includes external reflectors 315 that can be used with a body 302 having at least a portion of which is not tapered. FIG. 2 is a schematic illustration of light unit 300 shown without light emitters, for clarity. In this case reflectors 315 confine light ray 308C that does not meet the TIR condition (i.e. its AOI is not greater than the Critical Angle) until it is coupled into tapered portion 320. External reflectors 315 can run parallel to the entirety of non-extraction surfaces 313A and 313B of non-tapered portion 324 and tapered portion 320 of body 302 (in other words the reflectors 315 are “tiled”). In another embodiment illustrated in FIG. 3, external reflectors 415 can have a single slope with respect to the entire body 302, including the tapered portion 320 and non-tapered portion 324. For convenience in description, the transition point between tapered portion 320 and non-tapered portion 324 will be referred to as a non-tapered output 326 and tapered input 328. It should be understood that this is an arbitrary reference, and alternatively, this point could, for example, refer to the “extraction surface” of the non-tapered portion.

As illustrated in FIG. 2, light ray 308C, which has escaped body 302 (due to an AOI of less than the critical angle) continually reflects off of reflectors 315 and propagates through body 302 with substantially no change in the AOI as it exits body 302 into one of air gaps 316A or 316B. Light ray 308C does not begin to approach the TIR condition until after it encounters tapered portion 320. This is due to the fact that normal lines exemplified by 322A and 322B on opposing non-extractor surfaces 313A and 313B at non-tapered portion 324 are substantially parallel. The result is that the AOI of light ray 308C does not significantly change. After light ray 308C enters tapered portion 320, normal lines, exemplified by 322D and 322E become skewed, and the AOI of light ray 308C changes as it encounters non-extraction surfaces 313A and 313B until light ray 308C achieves TIR, as shown at point 212A. This process is the same for the light unit (or illumination system) illustrated in FIG. 3 at 400, regardless of the fact that external reflectors 415 have a single slope for the length of body 302. As illustrated, normal lines 422A and 422B are substantially parallel, while normal lines 422C and 422D are skewed, such that light ray 408C enters the TIR condition after entering tapered portion 320 of body 302 (shown at point 412).

Tapered portion 320 of body 302 additionally has an advantage of functioning as an output extractor, reducing the amount of fluorescent light that would otherwise be totally internally reflected at the extraction surface 312 (versus using a non-tapered body.) To form tapered body 302, different types of tapered portions 320 in the form of output extractors may be coupled to the non-tapered portion 324. In one such approach, a tapered, transmissive rod or tunnel is coupled to the non-tapered output 326 for use as an output extractor and to form tapered portion 320 of body 302. The tunnel is shaped to closely couple to the non-tapered output 326. If the non-tapered output 326 and the extractor are sufficiently matched (i.e., in size, shape, and refractive index), then light can be efficiently coupled from non-tapered portion 324 into the tapered portion 320 by placing the tapered input 328 against, or within less than one wavelength of, the non-tapered output 326, preferably around or less than one-quarter of a wavelength. An index matching material, for example an index matching oil or an optical adhesive, may also be used between the extractor and the non-tapered output 326. The extractor may be made of any suitable transparent material, for example a glass or a polymer.

Reflection of fluorescent light in the extractor tends to direct the fluorescent light along the z-direction, and so the angular spread of the fluorescent light at the output of the tunnel (i.e., the extraction face 312) is less than the angular spread of the light as it enters the tapered portion 320 from the non-tapered portion 324. The reduced angular spread reduces the amount of fluorescent light that is totally internally reflected at the output surface (i.e., the extraction face 312).

The tapered portion 320 may be formed integrally with the non-tapered portion 324, for example the tapered portion 320 and the non-tapered portion 324 may be molded from a single piece of material, such as polymer material. Additionally, the tapered portion 320 may or may not contain fluorescent material.

The extraction face 312 of the tapered portion 320 may be perpendicular to the z-axis, or may be tilted, for example as is further described in published U.S. Patent Application No. 2005-0135761-A1. A tilted extraction face 312 may be useful, for example, where the extraction face 312 is being imaged by an image relay system to a tilted target. One example of a tilted target is a digital multimirror device (DMD), an example of which is supplied by Texas Instruments, Plano, Tex., as the DLP™ imager. A DMD has many mirrors positioned in a plane, each mirror being individually addressable to tilt between two positions. The DMD is typically illuminated by a light beam that is non-normal to the DMD mirror plane, i.e. the mirror plane is tilted relative to the direction of propagation of the illumination light, and the image light reflected by the DMD is reflected in a direction normal to the mirror plane.

The body of the present invention may take on many different shapes. In the exemplary embodiments illustrated in FIGS. 1-3, body 102 has a rectangular cross-section, parallel to the x-y plane. In other exemplary embodiments, the cross-section of the body (102, 302) may be different, for example, circular, triangular, elliptical, or polygonal, and may also be irregular. It should be noted that the cross-sectional area (in the x-y plane) of the body 102 illustrated in FIGS. 1A-1F and tapered portion 320 in FIGS. 2 and 3 can increase (i.e. the “taper” can occur) in just one dimension, or in two.

Reflectors 115, 315 and 415 shown in FIGS. 1-3 include a large air gap for illustration purposes. In a practical design, the air space preferably is kept small. Keeping the gaps small minimizes light escaping from the sides of the reflectors. For significant improvement in extraction efficiency, the air gap is preferably <10% of the width of the body 102, 302 at its small end. For typical designs this means that the air gap is less than 100 microns. While air is the typical substance in gap, the invention contemplates the use of other substances such as filling gaps 216 with a low refractive index dielectric or gas other than air.

Another reason to keep gaps small is that heat is generated in the fluorescent material due to the Stokes shift (difference between input and fluorescent photon energies) and non-radiative decay from the excited state. Many fluorescent materials exhibit thermal quenching effects, where the fluorescent quantum efficiency is reduced as the temperature increases (i.e., the light generated is decreased). Also, it is desirable to control the temperature of the fluorescent body to prevent possible damage to adjacent materials and structures.

Conventional forced-air cooling of the body may be problematic since dust and other contaminants from the air can accumulate on the surface of the body and increase losses of light reflecting from those surfaces. Additionally, the forced-air convection heat transfer coefficient for air velocities achievable with a fan is in the range of 6-30 W/m²*K. This may be lower than needed to achieve desired results.

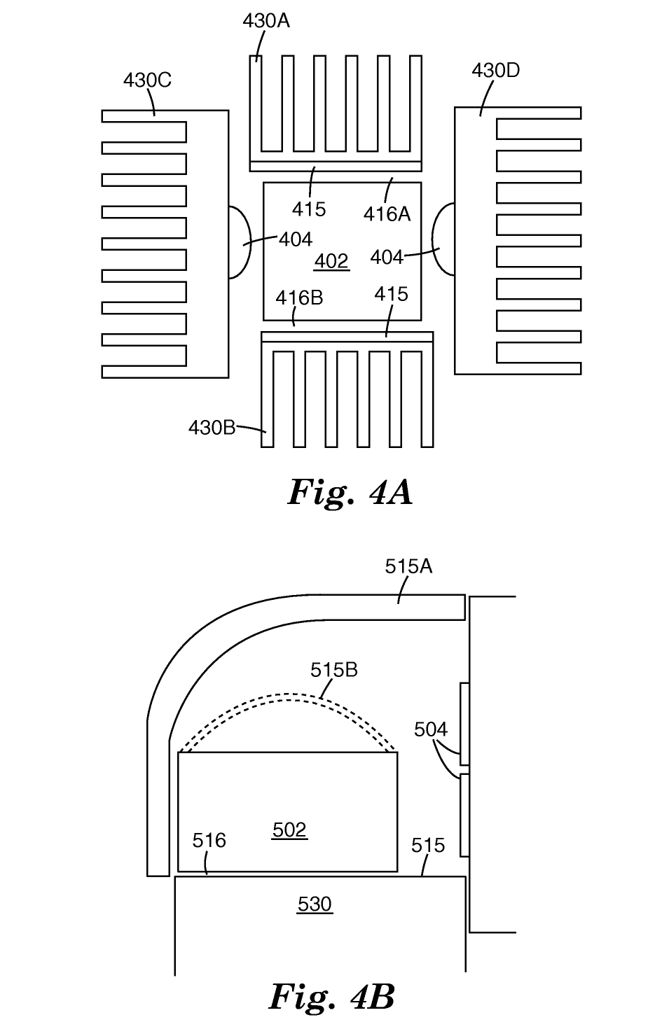

Cooling by direct mechanical contact of the sides of the slab to a heat sink will interfere with the TIR process due to the elimination of the low index material (air) as previously discussed. Small air gaps 416A and 416B in FIG. 4A are maintained between the surface of the body 402 and reflectors 415 so as to allow for TIR to occur while still allowing heat to be transferred to the heatsinks 430A and 430B. The heatsinks (430A and 430B), in turn, can be cooled in a conventional way, for example, by direct air or air with heat pipe or liquid heat transfer. The thickness of the gaps 416A and 416B can be chosen to assure that the thermal resistance of the layer of material in the gaps 416A and 416B (e.g. air) does not exceed heat transfer requirements. The gaps 416A and 416B can be filled with gasses (or other materials) other than air, especially those that have higher thermal conductivity than air, such as those in the following table:

| | Thermal |
|---|---|
| | Conductivity |
| Gas | (W/m K) |
| Air | 0.024 |
| N₂ | 0.024 |
| He | 0.143 |
| Ne | 0.046 |

Also, the gas in the gap can be at a pressure that is higher than atmospheric pressure which can further increase thermal conductivity.

By combining reflectors 415 with heatsinks 430A and 430B, with gaps 416A and 416B maintained between body 402 and reflectors 415, light output effectiveness can be increased. This occurs due to the decreased loss of TIR light (when a tapered body is used), potential increase in light absorption since light from light emitters can be directed into slab, and controlling the temperature of body 402 to limit quenching.

By controlling the clearance between body 402 and heatsinks 430A and 430B (and more particularly reflectors 415) we can control thermal resistance between body 402 and ambient air, and therefore the temperature of body 402. In one preferred embodiment, the distance of gaps 416A and 416B is held at 100 microns or less. Other preferred gap distances include distances of 0.075 mm and 0.03 mm. Light emitters 404 (for example, light emitting diodes, or LED's) are illustrated as the “pump light” source to illuminate body 402. These light emitters 404 are illustrated at being attached to heat sinks 430C and 430D. Additional reflective surfaces can be attached to heat sinks 430C and 430D, or placed between light emitters 404 and body 402 to further provide cooling to body 402. It may be useful to make these reflective surfaces dichroic to allow passing of the pump light through the reflector, while reflecting the fluorescing light. The current invention includes utilizing a minimal gap distance between the body 402 and the reflectors 415 to cool the body 402, regardless of whether body 402 is tapered (or includes a tapered portion) or is not tapered.

One embodiment of the current invention utilizes a curved reflector 515A, as shown in FIG. 4B. Although shown contacting body 502 only on one edge, a curved reflector could be provided which contacts the body on both reflector edges as shown in dotted lines at 515B. It should be noted that in the embodiment illustrated, reflector 515A is primarily a reflector used to direct pump light generated by light emitters 504, whereas reflector 515B is primarily used to reflect fluorescent light (as discussed and described previously). If both reflectors 515A and 515B are used together, reflector 515B would preferably be dichroic, allowing light from light emitters 504 to pass through, while reflecting fluorescent light from body 502. The curved reflector configuration can provide a different air flow space which may be desirable when designing a cooling system for the inventive light unit. Also illustrated are light emitters 504, reflector 515, gap 516 and heatsink 530.

While the discussion of the advantages of placing reflectors proximate to the body has been discussed primarily in the context of reclaiming lost TIR light, it should also be understood that reflectors can serve to confine the pump light as well as the fluorescent light. If external reflectors are placed on all side of the body, (i.e., between the light emitters and the body) it may be beneficial to make the reflectors dichroic, so that the pump light can pass through with a minimum loss.

Referring again to FIGS. 1A-1C, it should be noted that the particular selection of fluorescent material depends on the desired fluorescent wavelength and the wavelength of the light emitted from the light emitter 104. It is preferred that the fluorescent material absorb the pump light 106 emitted by the light emitter 104 efficiently, so that the pump light 106 is mostly, if not all, absorbed within the body 102. This enhances the efficiency of converting pump light 106 to useful fluorescent output light 109.

The light emitters 104 may be any suitable type of device that emits incoherent light. The present invention is believed to be particularly useful for producing a relatively bright beam using light from less bright light emitters.

In preferred exemplary embodiments, the light 106 emitted from the light emitters 104 is in a wavelength range that overlaps well with an absorption wavelength band of the fluorescent material. Also, it is useful if the light emitters 104 can be oriented so that there is a high degree of optical coupling of the emitted light 106 into the body 102. One suitable type of light emitter is the LED, which typically generates light 106 having a bandwidth in the range of about 20 nm to about 50 nm, although the light bandwidth may be outside this range. In addition, the radiation pattern from an LED is, in many cases, approximately Lambertian, and so relatively efficient coupling of the light 106 into the body 102 is possible. Other types of light emitter may also be used, for example a gas discharge lamp, a filament lamp and the like.

The light emitters 104 may optionally be provided on a substrate (shown optionally in dotted lines at 220). For example, where the light emitters 104 are LEDs, then substrate 220 may make electrical and thermal connections to the LEDs for providing power and cooling respectively. The substrate 220 may be reflective so that some light, exemplified by light ray 106A, directed from the light emitter 104 in direction away from the body 102 may be redirected towards the body 102. In addition, the substrate 220 may reflect pump light that has passed through the body 102 without being absorbed, exemplified by light ray 106B.

The maximum efficiency for coupling fluorescent light out of a body using total internal reflection may be calculated. As discussed above, generally it is preferred that the body has a higher refractive index, so that a greater fraction of the fluorescent light is totally internally reflected within the body.

The body 102 may be formed of any suitable material. For example, the body 102 may be formed of the fluorescent material itself, or may be formed of some dielectric material that is transparent to the fluorescent light and that contains the fluorescent material. Some suitable examples of dielectric material include inorganic crystals, glasses and polymer materials. Some examples of fluorescent materials that may be doped into the dielectric material include rare-earth ions, transition metal ions, organic dye molecules and phosphors. One suitable class of dielectric and fluorescent materials includes inorganic crystals doped with rare-earth ions, such as cerium-doped yttrium aluminum garnet (Ce:YAG), or doped with transition metal ions, such as chromium-doped sapphire or titanium-doped sapphire. Rare-earth and transition metal ions may also be doped into glasses.

Another suitable class of material includes a fluorescent dye doped into a polymer body. Many types of fluorescent dyes are available, for example from Sigma-Aldrich, St. Louis, Mo., and from Exciton Inc., Dayton, Ohio. Common types of fluorescent dye include fluorescein; rhodamines, such as Rhodamine 6G and Rhodamine B; and coumarins such as Coumarin 343 and Coumarin 6. The particular choice of dye depends on the desired wavelength range of the fluorescent light and the wavelength of the pump light. Many types of polymers are suitable as hosts for fluorescent dyes including, but not limited to, polymethylmethacrylate and polyvinylalcohol.

Phosphors include particles of crystalline or ceramic material that include a fluorescent species. A phosphor is often included in a matrix, such as a polymer matrix. In some embodiments, the refractive index of the matrix may be substantially matched, within at least 0.02, to that of the phosphor so as to reduce scattering. In other embodiments, the phosphor may be provided as nanoparticles within the matrix: there is little scattering of light within the resulting matrix due to the small size of the particles, even if the refractive indices are not well matched.

Other types of fluorescent materials include doped semiconductor materials, for example doped II-VI semiconductor materials such as zinc selenide and zinc sulfide. One example of an upconversion fluorescent material is a thulium-doped silicate glass, described in greater detail in co-owned U.S. Patent Publication No. 2004/0037538 A1. In this material, two, three or even four pump light photons are absorbed in a thulium ion (Tm³⁺) to excite the ion to different excited states that subsequently fluoresce. The particular examples of fluorescent species described above are presented for illustrative purposes only, and are not intended to be limiting.

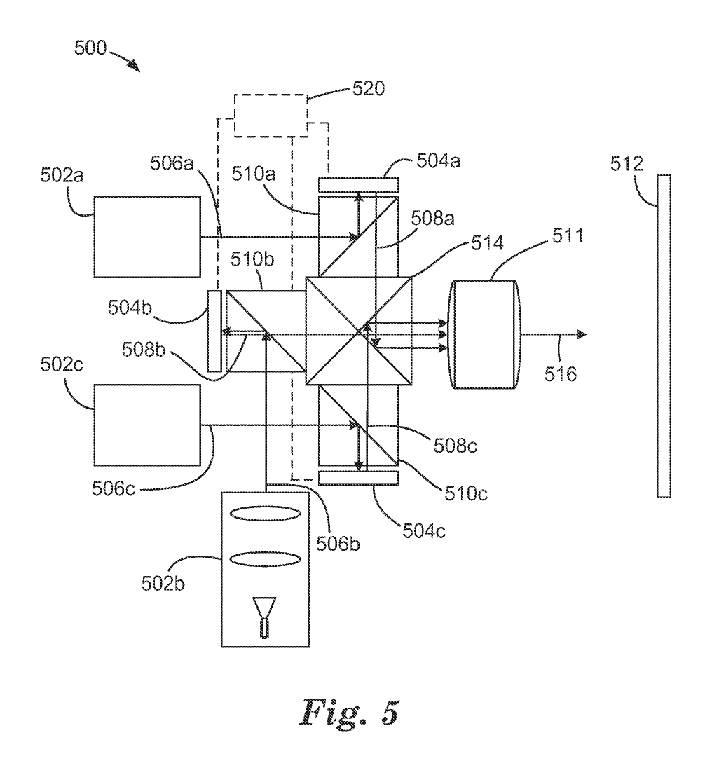

An exemplary embodiment of a projection system that might use a fluorescent volume light unit as described herein is schematically illustrated in FIG. 5. In this particular embodiment, the projection system 500 is a three-panel projection system, having light sources 502a, 502b, 502c that generate differently colored illumination light beams 506a, 506b, 506c, for example red, green and blue light beams. In the illustrated embodiment, the green light source 502b includes a fluorescent volume light unit. However, any, or all of the light source 502a, 502b, 502c may include fluorescent volume light units. The light sources 502a, 502b, 502c may also include beam steering elements, for example mirrors or prisms, to steer any of the colored illumination light beams 506a, 506b, 506c to their respective image-forming devices 504a, 504b, 504c.

The image-forming devices 504a, 504b, 504c may be any kind of image-forming device. For example, the image-forming devices 504a, 504b, 504c may be transmissive or reflective image-forming devices. Liquid crystal display (LCD) panels, both transmissive and reflective, may be used as image-forming devices. One example of a suitable type of transmissive LCD image-forming panel is a high temperature polysilicon (HTPS) LCD. An example of a suitable type of reflective LCD panel is the liquid crystal on silicon (LCoS) panel. The LCD panels modulate an illumination light beam by polarization modulating light associated with selected pixels, and then separating the modulated light from the unmodulated light using a polarizer. Another type of image-forming device, referred to a digital multimirror device (DMD), and supplied by Texas Instruments, Plano, Tex., under the brand name DLP™, uses an array of individually addressable mirrors, which either deflect the illumination light towards the projection lens or away from the projection lens. In the illustrated embodiment, the image-forming devices 504a, 504b, 504c are of the LCoS type.

The light sources 502a, 502b, 502c may also include various elements such as polarizers, integrators, lenses, mirrors and the like for dressing the illumination light beams 506a, 506b, 506c.

The colored illumination light beams 506a, 506b, 506c are directed to their respective image forming devices 504a, 504b and 504c via respective polarizing beamsplitters (PBSs) 510a, 510b and 510c. The image-forming devices 504a, 504b and 504c polarization modulate the incident illumination light beams 506a, 506b and 506c so that the respective reflected, colored image light beams 508a, 508b and 508c are separated by the PBSs 510a, 510b and 510c and pass to the color combiner unit 514. The colored image light beams 508a, 508b and 508c may be combined into a single, full color image beam 516 that is projected by a projection lens unit 511 to the screen 512.

The image-forming devices 504a, 504b, 504c may be coupled to a controller 520 (dashed lines) that controls the image displayed on the screen 512. The controller may be, for example, the tuning and image control circuit of a television, a computer or the like.

In the illustrated exemplary embodiment, the colored illumination light beams 506a, 506b, 506c are reflected by the PBSs 510a, 510b and 510c to the image-forming devices 504a, 504b and 504c and the resulting image light beams 508a, 508b and 508c are transmitted through the PBSs 510a, 510b and 510c. In another approach, not illustrated, the illumination light may be transmitted through the PBSs to the image-forming devices, while the image light is reflected by the PBSs.

Other embodiments of projection systems may use a different number of image-forming devices, either a greater or smaller number. Some embodiments of projection systems use a single image-forming device while other embodiments employ two image-forming devices. For example, projection systems using a single image-forming device are discussed in more detail in co-owned U.S. patent application Ser. No. 10/895,705 and projection systems using two image-forming devices are described in co-owned U.S. patent application Ser. No. 10/914,596. In a single panel projection system, the illumination light is incident on only a single image-forming panel. The incident light is modulated, so that light of only one color is incident on a part of the image-forming device at any one time. As time progresses, the color of the light incident on the image-forming device changes, for example, from red to green to blue and back to red, at which point the cycle repeats. This is often referred to as a “field sequential color” mode of operation. In other types of single panel projection systems, differently colored bands of light may be scrolled across the single panel, so that the panel is illuminated by the illumination system with more than one color at any one time, although any particular point on the panel is instantaneously illuminated with only a single color.

In a two-panel projection system, two colors are directed sequentially to a first image-forming device panel that sequentially displays an image for the two colors. The second panel is typically illuminated continuously by light of the third color. The image beams from the first and second panels are combined and projected. The viewer sees a full color image, due to integration in the eye.

### EXAMPLE

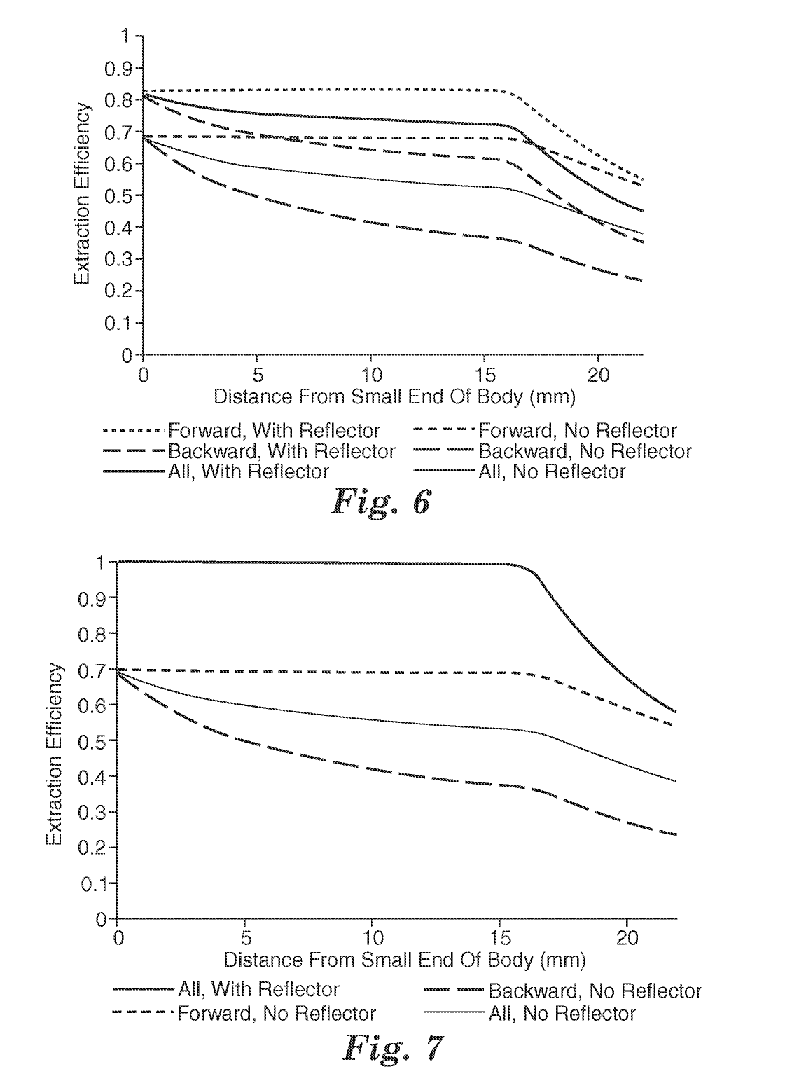

As a theoretical example, consider a Ce:YAG tapered body with index of refraction 1.835. The body is 50 mm long, with a cross section of 0.5 mm by 0.89 mm at the small end and 1.65 mm by 2.93 mm at the large end (continuously tapered). The first 22 mm of the body are excited by blue LEDs to produce fluorescence. The efficiency of light extraction varies along the 22 mm of the body that are generating fluorescent light. FIG. 6 illustrates the efficiency (the amount of light extracted from the extraction face versus the pumped light) as a function of the position where the fluorescent light is generated for a body with two external reflectors close to the two large faces of the body. The efficiency of the forward going light is constant until about 16 mm, at which point some of these rays undergo TIR at the output face of the slab. The efficiency of the backward going light is reduced continuously starting from the end of the slab. The reduction is caused by the increasing loss of light from the two sides of the slab with no reflector. FIG. 6 also illustrates the comparative case of a body where no reflectors are utilized.

The extraction efficiency as a function of slab position for a slab with external reflectors on all four sides is shown in FIG. 7. In this case (assuming 100% reflection) the extraction is perfect until the point at 16 mm where TIR begins to occur on the exit face. The case where no reflectors are used is included for comparison.

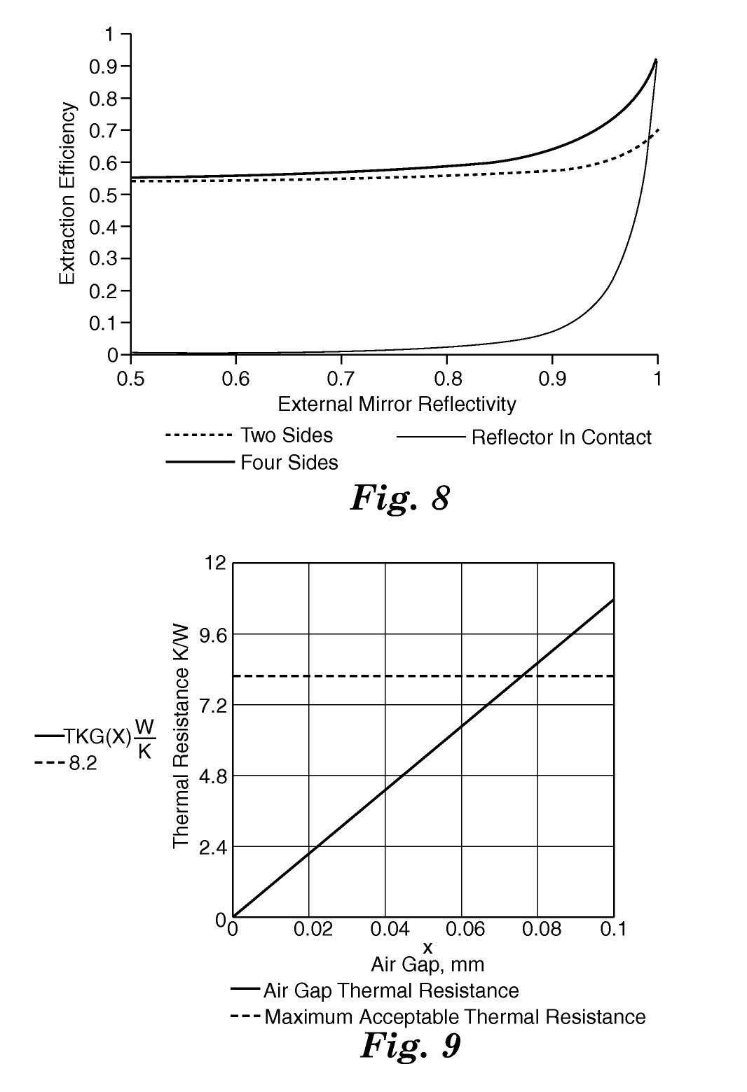

In practical systems, the improvement in extraction efficiency will be limited by the reflectivity of the external reflectors. FIG. 8 illustrates the calculated effect of reduction in reflectivity of the external reflector. Substantial increases in efficiency are realized for reflectivities above 95%, which is within the range of relatively simple enhanced metallic reflectors. This is compared to the case of a reflector placed directly on the slab, where the efficiency drops off extremely rapidly and >99% reflectivity is needed for any enhancement.

### Example

For a slab with dimensions 60×1.46×2.6 mm illuminated with 90 LED dies powered at 3 W each and assuming a 15% electrical-to-optical conversion in the LEDs and a 15% Stokes loss in the slab, the heat generated inside the slab will be about 6.1 W (=3 W*90*0.15*0.15). The surface area of the two large sides of the slab is 3.1 sq cm.

If maximum temperature of the slab cannot exceed 150° C. and ambient air temperature will be 45° C., then heat transfer needs to exceed 187 W/m²*K

$$\frac{6.1 W}{3.1 {cm}^{2} ( 150 - 45 ) K} = 187 \frac{\text{W}}{{m}^{2} \text{K}}$$

Then the maximum thermal resistance will be 17.2° K/W (105/6.1). Thermal resistance of the heat sink, for example UBC60-25B from “Alphanovatech” with forced air convection with velocity 2 m/sec, will be about 9° K/W.

Therefore thermal resistance of the air gap must not exceed 8.2° K/W (i.e. 17.2-9). Calculation of the thermal resistance of the air gap as shown in FIG. 9 confirms that an air gap less than 0.075 mm will be sufficient to cool down the slab as required.

We claim:

1. An illumination system, comprising:
a source of incoherent light capable of generating light in a first wavelength range;
an elongate body that emits light in a second wavelength range when illuminated by light in the first wavelength range, the body further including an extraction surface and a first non-extraction surface extending along at least a portion of the length of the body and disposed so as to share a common edge with the extraction surface;
wherein at least some of the light at the second wavelength is totally internally reflected at the non-extraction surface; and
at least one external reflector disposed proximate to the non-extraction surface so as to create a gap of less than 100 microns between the external reflector and the non-extraction surface.

2. The system as recited in claim 1 wherein the gap between the external reflector and the non-extraction surface is substantially filled with a fluid.

3. The system as recited in claim 2 wherein the fluid is air.

4. The system as recited in claim 1 and further comprising:
a second non-extraction surface disposed on an opposing side of the body as the first non-extraction surface;
a second external reflector disposed proximate to the second non-extraction surface so as to create a gap between the external reflector and the second non-extraction surface, wherein the source of incoherent light is disposed in a location other than between the second external reflector and the second non-extraction surface.

5. The illumination system of claim 5 and further comprising:
a third non-extraction surface on the body;
a fourth non-extraction surface on the body disposed on an opposing side of the body from the third non-extraction surface and substantially orthogonal to the first non-extraction surface;
a third external reflector disposed proximate to the third non-extraction surface so as to create a gap of less than 100 microns between the external reflector and the third non-extraction surface; and
a fourth external reflector disposed proximate to the fourth non-extraction surface so as to create a gap of less than 100 microns between the external reflector and the fourth non-extraction surface, wherein the source of incoherent light is disposed in a location other than between the fourth external reflector and the fourth non-extraction surface.

6. The illumination system of claim 1 wherein the cross-section of the body is generally rectangular in shape.

7. The illumination system of claim 1 wherein the reflector extends generally parallel to the non-extraction surface.

8. The system as recited in claim 1, wherein the body contains a fluorescent material that emits light in a second wavelength range different from the first wavelength range.

9. The system as recited in claim 1, wherein the at least a first source of incoherent light comprises a first source and at least a second source.

10. The system as recited in claim 1, wherein the at least a first light source comprises a plurality of light emitting diodes (LEDs) capable of emitting light in the first wavelength range, the first wavelength range being between about 400 nm and about 500 nm, and the second wavelength range lies between about 500 nm and about 600 nm.
